(19) United States
(12) Patent Application Publication
(10) Pub. No.: US 2020/0024878 A1
(43) Pub. Date: Jan. 23, 2020

(54) REFRIGERATOR PROVIDED WITH DOOR OPENING/CLOSING DEVICE

(71) Applicant: Daewoo Electronics Co., Ltd., Gwangju (KR)

(72) Inventor: Jae Sang KIM, Gwangju (KR)

(21) Appl. No.: 16/218,838

(22) Filed: Dec. 13, 2018

(30) Foreign Application Priority Data
Jul. 18, 2018 (KR) 10-2018-0083605

(51) Int. Cl. E05C 3/16; F25D 23/02; E05F 1/10; E05C 3/30

(52) U.S. Cl. CPC E05C 3/165; F25D 23/028; E05F 1/105; E05Y 2600/46; E05Y 2900/31; E05Y 2201/474; E05Y 2600/322; E05C 3/30

(57) ABSTRACT

A refrigerator having facilitated door opening and sealing functionality and comprising: a refrigerator body having a storage space; a refrigerator door rotatably installed in the refrigerator body to open and close the storage space; and a door opening/closing device configured to selectively lock the refrigerator door to the refrigerator body. The door opening/closing device includes: a rod part hinged to the refrigerator door and having a hook-shaped one end to be latched with a latching groove of the refrigerator body; a door handle connected to the other end of the rod part to rotate the rod part; and a first elastic member configured to apply a resilient force to the other end of the rod part in an upward direction.

### CROSS-REFERENCE TO RELATED APPLICATIONS

This application is based on and claims priority from Korean Patent Application No. 10-2018-0083605, filed on Jul. 18, 2018, the disclosure of which is incorporated herein in its entirety by reference for all purposes.

### TECHNICAL FIELD

The present disclosure relates to a refrigerator provided with a door opening/closing device.

### BACKGROUND

A refrigerator is an appliance for storing food at low temperatures and is configured to store food in a frozen state or a refrigerated state depending on the type and condition of food to be stored.

In such a refrigerator, cold air is generated by the heat exchange action of a refrigerant passing through a refrigeration cycle. In other words, the refrigerant supplies cold air to the refrigerator by repeatedly circulating a so-called refrigeration cycle consisting of compression, condensation, expansion and evaporation phases.

In general, the refrigerator may be manufactured in accordance with several various styles or types, including a top mount type in which a freezing compartment is provided on the upper side of a refrigeration compartment, a bottom freeze type in which a freezing compartment is provided on the lower side of the refrigeration compartment, and a side-by-side type in which a freezing compartment and a refrigeration compartment are formed on the left and right side, and the like.

The storage space formed inside the various kinds of refrigerators may be selectively shielded by a refrigerator door.

Furthermore, the refrigerator door may be provided with a door handle that can be physically gripped by a user to easily open and close the refrigerator door. The user may rotate or pull the door handle to open and close the refrigerator door.

However, in the conventional refrigerator, when the door is opened, an excessive force may have to be applied to door due to the negative pressure in the refrigerator or the freezer compartments. Furthermore, it is possible that the door may not completely close, resulting in leakage of cold air.

Therefore, there is a need for a door opening/closing device capable of easily opening and closing a refrigerator door and improving the door-sealing performance of a refrigerator.

### SUMMARY

Embodiments of the present disclosure provide a refrigerator provided with a door opening/closing device that is capable of easily opening and closing a refrigerator door and improving the door-sealing performance of the refrigerator.

In accordance with an embodiment, there is provided a refrigerator comprising: a refrigerator body having a storage space; a refrigerator door rotatably installed in the refrigerator body to open and close the storage space; and a door opening/closing device configured to selectively lock the refrigerator door to the refrigerator body, wherein the door opening/closing device includes: a rod part hinged to the refrigerator door and having a hook-shaped end, on a first end, to be latched with a latching groove of the refrigerator body; a door handle connected to a second end of the rod part to rotate the rod part; and a first elastic member configured to apply a resilient force to the second end of the rod part in an upward direction.

In accordance with an embodiment of the present invention, the rod part may be hinged to an upper surface of the refrigerator door, and the first elastic member may be inserted into the refrigerator door on an upper side of the refrigerator door and coupled at the first end thereof to the second end of the rod part.

When the refrigerator door is closed, the first end of the rod part may be inserted into the latching groove, and a lower surface of the rod part may make contact with an upper surface of the refrigerator door and an upper surface of the refrigerator body.

The door handle may be slidably coupled to the refrigerator door, and the rod part is rotated when the door handle slides.

The door handle may be coupled to the rod part by either of a wire structure or a link structure.

When the door handle slides downward, the second end of the rod part may be rotated downward, and when the door handle slides upward, the second end of the rod part may be rotated upward.

When the second end of the rod part is rotated upward with the refrigerator door kept closed, the first end of the rod part may be inserted and fixed into the latching groove, and when the second end of the rod portion is rotated downward with the refrigerator door kept closed, the first end of the rod part may be removed from the latching groove.

The refrigerator body may be provided with a door opening assistance member for applying an external force to the rod part in a direction in which the refrigerator door is opened.

In accordance with an embodiment of the present invention, the door opening assistance member may include a cover portion having an internal space and coupled to an upper surface of the refrigerator body, a second elastic member disposed inside the cover portion, and a pressing portion connected to the second elastic member and capable of making contact with the rod part.

One end of the rod part may be inserted and fixed into the latching groove, the pressing portion may make contact with the first end of the rod part and apply an external force to the first end of the rod part to prevent the first end portion of the rod part from being removed from the latching groove, and when the first end of the rod part is removed from the latching groove, the pressing portion may make contact with the first end of the rod part and apply an external force to the refrigerator door in a direction in which the refrigerator door is opened.

With the refrigerator according to the embodiment of the present disclosure outfitted with the door opening and closing device described above, it possible to easily open and close the refrigerator door and to improve the door-sealing performance of the refrigerator.

### BRIEF DESCRIPTION OF THE DRAWINGS

FIG. 1 is a schematic perspective view of a refrigerator according to an embodiment of the present disclosure.

FIG. 2 is a schematic sectional view taken along line A-A′ in FIG. 1.

FIG. 3 is a schematic enlarged view of a portion indicated by “B” in FIG. 2.

FIG. 4 is a schematic sectional view illustrating a state in which a door handle is moved downward in a refrigerator door according to an embodiment of the present disclosure.

FIG. 5 is a schematic sectional view illustrating a state in which the refrigerator door according to an embodiment of the present disclosure is opened.

### DETAILED DESCRIPTION

Hereinafter, configurations and operations of embodiments will be described in detail with reference to the accompanying drawings. The following description is one of various patentable aspects of the disclosure and may form a part of the detailed description of the disclosure.

However, in describing the disclosure, detailed descriptions of known configurations or functions that may obscure aspects of the disclosure may be omitted.

The disclosure may be variously modified and may include various embodiments. Specific embodiments will be exemplarily illustrated in the drawings and described in the detailed description of the embodiments. However, it should be understood that they are not intended to limit the disclosure to specific embodiments but rather to cover all modifications, similarities, and alternatives which are included in the spirit and scope of the disclosure.

The terms used herein, including ordinal numbers such as “first” and “second” may be used to describe, and not to limit, various components. The terms simply distinguish the components from one another.

When it is said that a component is “connected” or “linked” to another component, it should be understood that the former component may be directly connected or linked to the latter component or a third component may be interposed between the two components.

Specific terms used in the present application are used simply to describe specific embodiments without limiting the disclosure. An expression used in the singular encompasses the expression of the plural, unless it has a clearly different meaning in the context.

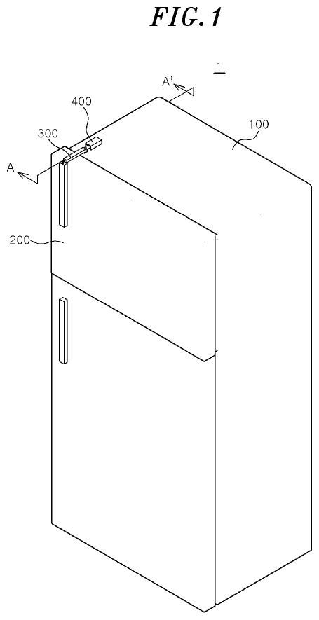

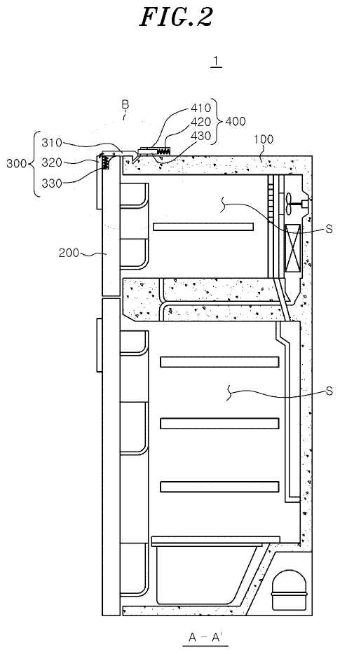

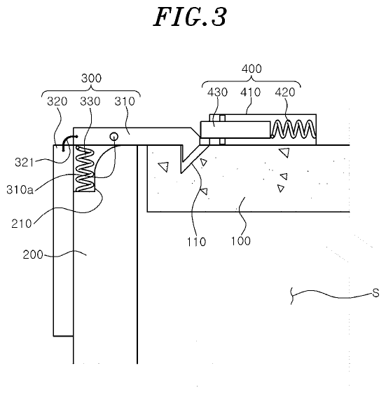

FIG. 1 is a schematic perspective view of a refrigerator according to an embodiment of the present disclosure. FIG. 2 is a schematic sectional view taken along line A-A′ in FIG. 1. FIG. 3 is a schematic enlarged view of a portion indicated by “B” in FIG. 2.

Referring to FIGS. 1 to 3, the refrigerator 1 according to an embodiment of the present disclosure may include a refrigerator body 100 having a storage space S, a refrigerator door 200 for opening and closing the storage space S of the refrigerator body 100, and a door opening/closing device 300 for selectively locking the refrigerator door 200 to the refrigerator body 100.

In this regard, the refrigerator 1 is used for storing food at low temperatures and may be manufactured in accordance with various types including, for instance, a top mount type in which a freezing compartment is provided on the upper side of a refrigeration compartment, a bottom freeze type in which a freezing compartment is provided on the lower side of the refrigeration compartment, and a side-by-side type in which a freezing compartment and a refrigeration compartment are formed on the left and right side, and the like. Although only a side-by-side type refrigerator is shown in FIG. 1, the scope of the present disclosure may also be applicable to various refrigerators commonly used in the art and well known.

The refrigerator body 100 may form an outer shell of the refrigerator 1 and may include a storage space S for storing food. The storage space S may be opened and closed by the refrigerator door 200 rotatably installed in the refrigerator body 100.

The refrigerator door 200 may be rotatably hinged to the refrigerator body 100. A magnet (not shown) for coupling with the refrigerator body 100 may be provided on the rear surface of the refrigerator door 200, e.g., on the edge of the surface of the refrigerator door 200 facing the refrigerator body 100.

Further, a separate gasket, a sealing member, or the like may be disposed on the rear edge of the refrigerator door 200 to improve the sealing performance. The use of a magnet, a gasket, a sealing member, or the like for coupling the refrigerator door 200 and the refrigerator body 100 is well known in the art and will not be described in detail.

The refrigerator door 200 may be provided with a door opening/closing device 300 for easily rotating the refrigerator door 200 from the refrigerator body 100 and improving the sealing performance of the refrigerator door 200 and the refrigerator body 100.

The door opening/closing device 300 may enable the refrigerator door 200 to easily rotate from the refrigerator body 100 when the refrigerator door 200 is opened. In other words, in the refrigerator 1, the storage space S is maintained at a low temperature. Therefore, when the external air introduced into the storage space S is cooled, the pressure in the storage space S may be lowered and a negative pressure may result. If the negative pressure is generated in the storage space S as described above, a large force is then required to open the refrigerator door 200. Therefore, the door opening/closing device 300 may be provided to easily open the refrigerator door 200 even when the negative pressure is generated in the storage space S of the refrigerator 1.

In addition, the door opening/closing device 300 may be provided to improve the sealing performance of the refrigerator door 200 and the refrigerator body 100. In other words, when the refrigerator door 200 is only magnetically coupled to the refrigerator body 100, the refrigerator door 200 may be opened by a relatively weak force. Accordingly, the door opening/closing device 300 may be provided to prevent the refrigerator door 200 from being opened and to improve the sealing force between the refrigerator door 200 and the refrigerator body 100.

For example, the door opening/closing device 300 may include a rod part 310 hinged to the refrigerator door 200 and having a hook-shaped first end to be latched with a latching groove 110 of the refrigerator body 100, a door handle 320 connected to the second end of the rod part 310 to rotate the rod part 310, and a first elastic member 330 for applying an external force to the second end of the rod part 310 in such a direction as to rotate the second end portion of the rod part 310 upward.

The rod part 310 may be coupled to the refrigerator door 200. For example, the rod part 310 may be rotatably hinged to the upper surface of the refrigerator door 200. When the refrigerator door 200 is closed, the rod part 310 may rotate so that the first end of the rod part 310 can be inserted into the latching groove 110 of the refrigerator body 100 and fixed. In other words, when the refrigerator door 200 is closed, the first end of the rod part 310 may be inserted into the latching groove 110, and the lower surface of the rod part 310 may make contact with the upper surface of the refrigerator door 200 and the upper surface of the refrigerator body 100. Therefore, the refrigerator door 200 may be locked to the refrigerator body 100. To this end, the first end of the rod part 310 may have a hook shape so as to be latched with the latching groove 110 of the refrigerator body 100.

The second end of the rod part 310 may be connected to the first elastic member 330. The first elastic member 330 may be made of any material having elasticity. For example, the first elastic member 330 may be a coil spring. The first elastic member 330 may be inserted into a first elastic member insertion groove 210 provided on the upper surface of the refrigerator door 200. One end of the first elastic member 330 may be connected to the second end of the rod part 310. The first elastic member 330 may apply an elastic force to the second end of the rod part 310 in such a direction as to rotate the second end of the rod part 310 upward. The upward rotation direction may refer to a direction of upward movement about a hinge point 310a of the rod part 310 and may refer to a clockwise direction in FIG. 3.

The second end of the rod part 310 may be connected to the door handle 320. The door handle 320 is a portion gripped by the user when the refrigerator door 200 is opened and closed. The door handle 320 may be connected to the second end of the rod part 310 to rotate the rod part 310. The door handle 320 may be slidably coupled to the refrigerator door 200 so as to move in a vertical direction.

For example, a guide rail (not shown) may be formed on the front surface of the refrigerator door 200, and a wheel or the like sliding along the guide rail may be coupled to the rear surface of the door handle 320 so that the door handle 320 can slide.

When the door handle 320 slides downward, the second end of the rod part 310 may be rotated downward. In other words, when the door handle 320 is slid downward in FIG. 3, the rod part 310 may rotate counterclockwise about the hinge point 310a. Conversely, when the door handle 320 is slid upward, the second end of the rod part 320 may rotate upward. In other words, when the door handle 320 is slid upward in FIG. 3, the rod part 310 may rotate clockwise about the hinge point 310a.

When the door handle 320 is moved upward to rotate the second end portion of the rod part 310 upward in a state in which the refrigerator door 200 is closed, one end of the rod part 310 may be inserted into and latched with the latching groove 110. When the door handle 320 is moved downward to rotate the second end portion of the rod part 310 downward in a state in which the refrigerator door 200 is closed, the first end of the rod part 310 may be removed from the latching groove 110.

The door handle 320 may be coupled to the rod part 310 by a wire 321. Alternatively, a slot may be formed in the end portion of the door handle 320 and a structure inserted into the slot (to allow sliding) may be provided at the second end of the rod part 310, so that the door handle 320 and the rod part 310 can be coupled by a link structure.

Since the rod part 310 of the door opening/closing device 300 can be fixed to the refrigerator body 100, the refrigerator 1 according to the embodiment of the present disclosure may advantageously offer improved sealing performance.

The refrigerator body 100 may be provided with a door opening assistance member 400 for applying an external force to the rod part 310 in a direction in which the refrigerator door 200 is opened. For example, the door opening assistance member 400 may include a cover portion 410 having an internal space and coupled to the upper surface of the refrigerator body 100, a second elastic member 420 disposed inside the cover portion 410, and a pressing portion 430 connected to the second elastic member 420 and capable of making contact with the rod part 310.

The door opening assistance member 400 may apply an external force to the rod part 310 to prevent the rod part 310 from being separated from the latching groove 110. The door opening assistance member 400 may enable the user to open the refrigerator door 200 without needing to apply a large force.

In other words, when the first end of the rod part 310 is inserted into the latching groove 110, the pressing portion 430 applies an external force to the first end of the rod part 310. This makes it possible to increase the frictional force between the rod part 310 and the latching groove 110. Therefore, it is possible to prevent the rod part 310 from being removed from the latching groove 110.

When the user moves the door handle 320 downward and removes the first end of the rod part 310 from the latching groove 110, in order to open the refrigerator door 200, the pressing portion 430 may make contact with the first end of the rod part 310, thereby applying an external force to the refrigerator door 200 in a direction in which the refrigerator door 200 is opened. Therefore, the user can easily open the refrigerator door 200 without applying a large force.

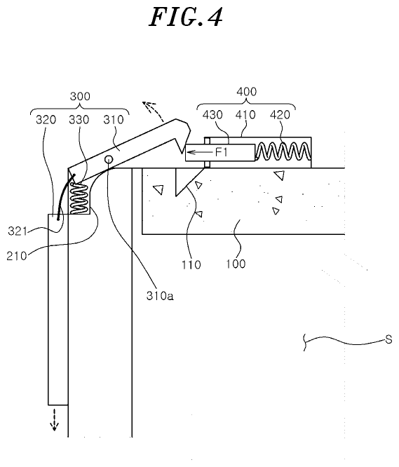

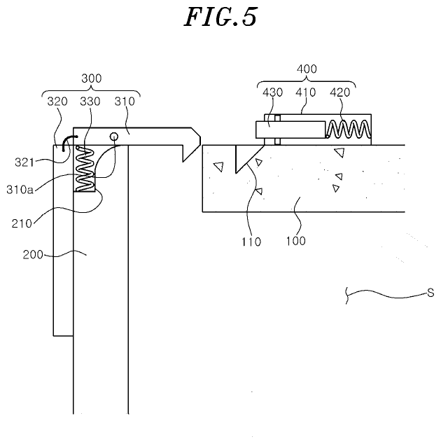

Hereinafter, the opening and closing process of the refrigerator door 200 according to an embodiment of the present disclosure will be described with reference to FIGS. 4 and 5.

FIG. 4 is a schematic sectional view illustrating a state in which the door handle is moved downward in the refrigerator door according to an embodiment of the present disclosure. FIG. 5 is a schematic sectional view illustrating a state in which the refrigerator door according to an embodiment of the present disclosure is opened.

Referring to FIGS. 4 and 5, when the user desires to open the refrigerator door 200, the user may grip the door handle 320 and may slide the door handle 320 downward. As the door handle 320 is slid downward, the rod part 310 connected to the door handle 320 is rotated so that the first end of the rod part 310 is removed from the latching groove 110 of the refrigerator body 100. At this time, the pressing portion 430 of the door opening assistance member 400 comes into contact with the rod part 310 and exerts an external force F1 in a direction in which the refrigerator door 200 is opened. Accordingly, the user can easily open the refrigerator door 200 in this fashion.

From the foregoing, it will be appreciated that various embodiments of the present disclosure have been described herein for purposes of illustration, and that various modifications may be made without departing from the scope and spirit of the present disclosure. The exemplary embodiments disclosed in the specification of the present disclosure do not limit the present disclosure. The scope of the present disclosure will be interpreted by the claims below, and it will be construed that all techniques within the scope equivalent thereto belong to the scope of the present disclosure.

What is claimed is:

1. A refrigerator, comprising:
a refrigerator body having a storage space;
a refrigerator door rotatably installed in the refrigerator body to open and close the storage space; and
a door opening/closing device configured to selectively lock the refrigerator door to the refrigerator body,
wherein the door opening/closing device includes:
a rod part hinged to the refrigerator door and having a hook-shaped first end to be latched with a latching groove of the refrigerator body;
a door handle coupled to a second end of the rod part to rotate the rod part; and
a first elastic member configured to apply a resilient force to the second end of the rod part in an upward direction.

2. The refrigerator of claim 1, wherein the rod part is hinged to an upper surface of the refrigerator door, and
wherein the first elastic member is inserted into the refrigerator door on an upper side of the refrigerator door and coupled at one end thereof to the second end of the rod part.

3. The refrigerator of claim 1, wherein when the refrigerator door is closed, the first end of the rod part is inserted into the latching groove, and a lower surface of the rod part contacts upper surfaces of both the refrigerator door and the refrigerator body.

4. The refrigerator of claim 1, wherein the door handle is slidably coupled to the refrigerator door, and the rod part is rotated when the door handle slides.

5. The refrigerator of claim 4, wherein the door handle is coupled to the rod part by one of: a wire and a link structure.

6. The refrigerator of claim 4, wherein when the door handle slides downward, the second end of the rod part is configured to rotate downward, and
when the door handle slides upward, the second end of the rod part is configured to rotate upward.

7. The refrigerator of claim 6, wherein when the other end of the rod part is rotated upward with the refrigerator door remaining closed, the first end of the rod part is inserted and fixed into the latching groove, and
when the second end of the rod part is rotated downward with the refrigerator door remaining closed, the first end of the rod part is removed from the latching groove.

8. The refrigerator of claim 1, wherein the refrigerator body includes a door opening assistance member for applying an external force to the rod part in an opening direction of the refrigerator door.

9. The refrigerator of claim 8, wherein the door opening assistance member includes:
a cover portion having an internal space and coupled to an upper surface of the refrigerator body;
a second elastic member disposed inside the cover portion; and
a pressing portion coupled to the second elastic member and configured to make contact with the rod part.

10. The refrigerator of claim 9, wherein when the first end of the rod part is inserted and fixed into the latching groove, the pressing portion contacts the first end of the rod part and applies an external force to the first end of the rod part to prevent the first end portion of the rod part from detaching from the latching groove, and
when a first end of the rod part is removed from the latching groove, the pressing portion contacts the first end of the rod part and applies an external force to the refrigerator door in an opening direction of the refrigerator door.

11. A refrigerator having facilitated door opening and sealing functionality, the refrigerator comprising:
a body including a storage space and a latching groove;
a door rotatably installed in the body to selectively open and close the storage space; and
a door opening/closing device configured to selectively secure the door to the body and to facilitate door opening,
wherein the door opening/closing device includes:
a rod hinged to the door and comprising a hook-shaped first end to be latched with the latching groove of the body;
a door handle coupled to a second end of the rod and configured to rotate the rod; and
a first elastic member configured to apply a force to the second end of the rod in an upward direction.

12. The refrigerator of claim 11, wherein the rod is hinged to an upper surface of the door, and
wherein the first elastic member is inserted into the door on an upper side of the door and coupled at one end thereof to the second end of the rod.

13. The refrigerator of claim 11, wherein when the door is closed, the first end of the rod is inserted into the latching groove, and a lower surface of the rod contacts upper surfaces of both the door and the body.

14. The refrigerator of claim 11, wherein the door handle is slidably coupled to the door, and the rod is rotated when the door handle slides.

15. The refrigerator of claim 14, wherein the door handle is coupled to the rod by a wire.

16. The refrigerator of claim 14, wherein the door handle is coupled to the rod by a link structure.

17. The refrigerator of claim 14, wherein when the door handle slides downward, the second end of the rod rotates downward, and
when the door handle slides upward, the second end of the rod rotates upward.

18. The refrigerator of claim 17, wherein when the second end of the rod is rotated upward with the door remaining closed, the first end of the rod is inserted and fixed into the latching groove, and
when the second end of the rod is rotated downward with the refrigerator door remaining closed, the first end of the rod is removed from the latching groove.

19. The refrigerator of claim 11, wherein the body comprises a door opening assistance member configured to apply an external force to the rod in an opening direction of the door.

20. The refrigerator of claim 19, wherein the door opening assistance member includes:
a cover portion having an internal space and coupled to an upper surface of the body;
a second elastic member disposed inside the cover portion; and
a pressing portion coupled to the second elastic member and configured to make contact with the rod,
wherein when the first end of the rod is inserted and fixed into the latching groove, the pressing portion contacts the first end of the rod and applies an external force thereto to prevent the first end portion of the rod from detaching from the latching groove, and
when a first end of the rod is removed from the latching groove, the pressing portion contacts the first end of the rod and applies an external force to the door in an opening direction of the door.
